(19) United States
(12) Patent Application Publication
(10) Pub. No.: US 2003/0088865 A1
(43) Pub. Date: May 8, 2003

(54) Apparatus and method for incrementally performing remote loading

(76) Inventors: Chae Deok Lim, Taejon (KR); Chang Woo Pyo, Seoul (KR); Deokkyun Gyun Wu, Goyang-Si (KR); Heung nam Kim, Taejon (KR); Chae Kyu Kim, Taejon (KR)

Correspondence Address: JACOBSON HOLMAN PLLC, 400 SEVENTH STREET N.W., SUITE 600, WASHINGTON, DC, 20004, US

(21) Appl. No.: 10/032,147

(22) Filed: Dec. 31, 2001

(30) Foreign Application Priority Data
Nov. 2, 2001 (KR) 2001-68232

(51) Int. Cl. G06F 9/44; G06F 9/45

(52) U.S. Cl. 717/167; 717/140

(57) ABSTRACT

An apparatus and method for incrementally performing a remote loading is disclosed. The incremental remote loading apparatus includes dependent reader modules for analyzing the object file according to a object type and detecting an independent linking information and independent linker module for receiving a detected liking information, downloading the object file to a target system and rearranging target modules of the target system. The present invention provides convenience to developers by linking object files to the target system without following a linking order and reduces a development time by changing a dependent environment without changing whole developing environment and reduces communication time by recognizing various object file type and partly loading/unloading related modules to target system.

### FIELD OF THE INVENTION

The present invention relates to an apparatus for remotely loading a program; and, more particularly, to incremental remote loading apparatus for incrementally linking object files while loading one object file and linking target modules by a host system at a remote location, the method of incremental remote loading and a computer readable recording medium for executing the incremental remote loading method.

### DESCRIPTION OF THE RELATED ARTS

Generally, an Internet appliance such as a digital television set or a Web television set contains an on-board system, which may be a small computer. However, the on-board system dose not provides real computer-controllable functions comparing to a personal computer PC. The on-board system typically has an inappropriate environment for an application program. Therefore, it is hard to develop a program for the on-board system such as a debugger or a program requiring many resources.

Hence, a new way of providing an application program environment for the on-board system has been developed and introduced. A host-target type application program environment is introduced. A remote computer or the host system is connected to the target system by a communication network. The host computer can be a personal computer PC or a workstation. The host system provides environments and resources for running an application program on the target system.

The host-target type application program environment for the on-board system has been provided to many companies with a real time operating system.

A linker of the host system downloads the cross-compiled object file to the target system and links a cross-compiled object file to modules of the target system. The modules manage downloading and linking the cross-compiled object file to the target system is managed.

The modules are selected and implemented in the conventional remote development environment according to a type of the object files. If the type of the object file is changed then the modules are reconstructed according to newly changed type of the object file. It is a time consuming process.

A linking module in the conventional remote development environment links and downloads the object files in response to an order of downloading for obtaining an accurate result in case of downloading files having related information with other files. Therefore, a user needs to follow the order of downloading the object files or the host system need to combines multiple object files to one object file before downloading. It gives inconvenience to user and increases development time.

### SUMMARY OF THE INVENTION

It is, therefore, an object of the present invention to provide an incremental remote loading apparatus for incrementally linking object files while loading one object file at a time and linking target modules by a host system at a remote location.

It is another object of the present invention to provide an incremental remote loading method.

It is further another object of the present invention to provide a computer readable recording medium for executing the incremental remote loading.

In accordance with an aspect of the present invention, there is provided an incremental remote loading apparatus, including: a dependent reader module for receiving a cross-compiled object file from a program development tool, analyzing the cross-compiled object file according to a type of an object file and detecting independent linking information from the type of the object file; and an independent linker module for receiving the detected liking information from the dependent reader module, downloading the object file to a target system by using the detected linking information and rearranging target modules of the target system.

In accordance with another aspect of the present invention, there is also provided an incremental remote loading method, including steps of a) at a reader module, analyzing necessary linking information for liking object files; b) at a linker, allocating a target memory space for sections according to a section information; c) determining whether each entry of a symbol table is defined or not and calculating addresses of sections in a target memory; d) determining, according to a result of the step c), whether a symbol defined or not in case the symbol is stored in the symbol table or inserting a new symbol to the symbol table in case the symbol is not in the symbol table and determining whether the new symbol is defined or not; e) rearranging an object file if a symbol is defined or rearranging the object file after transforming a defined symbol in case a symbol is not defined; and f) transmitting a rearranged object file to a target memory.

In accordance with further another aspect of the present invention, there is also provided a computer readable recording medium for executing the incremental remote loading method, including functions of: a) at a reader module, analyzing necessary linking information for liking object files; b) at a linker, allocating a target memory space for sections according to a section information; c) determining whether each entry of a symbol table is defined or not and calculating addresses of sections in a target memory; d) determining, according to a result of the step c), whether a symbol defined or not in case the symbol is stored in the symbol table or inserting a new symbol to the symbol table in case the symbol is not in the symbol table and determining whether the new symbol is defined or not; e) rearranging an object file if a symbol is defined or rearranging the object file after transforming a defined symbol in case a symbol is not defined; and f) transmitting a rearranged object file to a target memory.

The present invention reduces necessary communication time between the host system and the target system by dynamically recognizing various object file type, providing necessary operations according to various object file type, partly loading/unloading related modules to target system. In other word, the present invention reduces an application development time for the on-board system by supporting independent object module types and individually loading/unloading modules for linking object modules in a process of loading compiled object modules from the host system to the target system through the network.

For supporting independent object module types and individually loading/unloading modules, the present invention divides the loader to a dependent module and an independent module according to a type of the object file. The dependent module detects independent linking information and the independent module performs a linking process according to the independent linking information. Such a distinguishing the loader increases ability to be transparent development environment and resources to the target system in an application development environment.

The present invention provides convenience to an application program developer by providing the incremental remote loading method, which links object files to the target system without following a linking order and rearranges not only object files being loaded but also loaded target modules.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram illustrating a general application program development environment for on-board system;

FIG. 2 is a block diagram illustrating an incremental remote loading apparatus including the target manager in accordance with the preferred embodiment of the present invention;

FIG. 3 is a diagram describing the linker 230 in FIG. 2;

FIG. 4 is a diagram illustrating a structure of linking information in accordance with the present invention;

FIG. 5 is a diagram describing a linking of two C programs in accordance with the present invention;

FIG. 6 is a diagram illustrating the incremental remote linking method in accordance with the preferred embodiment of the present invention;

FIG. 7 is a diagram illustrating incremental remote linking steps of add.o in accordance with the preferred embodiment of the present invention; and

FIG. 8 is a flowchart describing the incremental remote loading method for the on-board system in accordance with the preferred embodiment of the present invention.

### DETAILED DESCRIPTION OF THE INVENTION

Other objects and aspects of the invention will become apparent from the following description of the embodiments with reference to the accompanying drawings, which is set forth hereinafter.

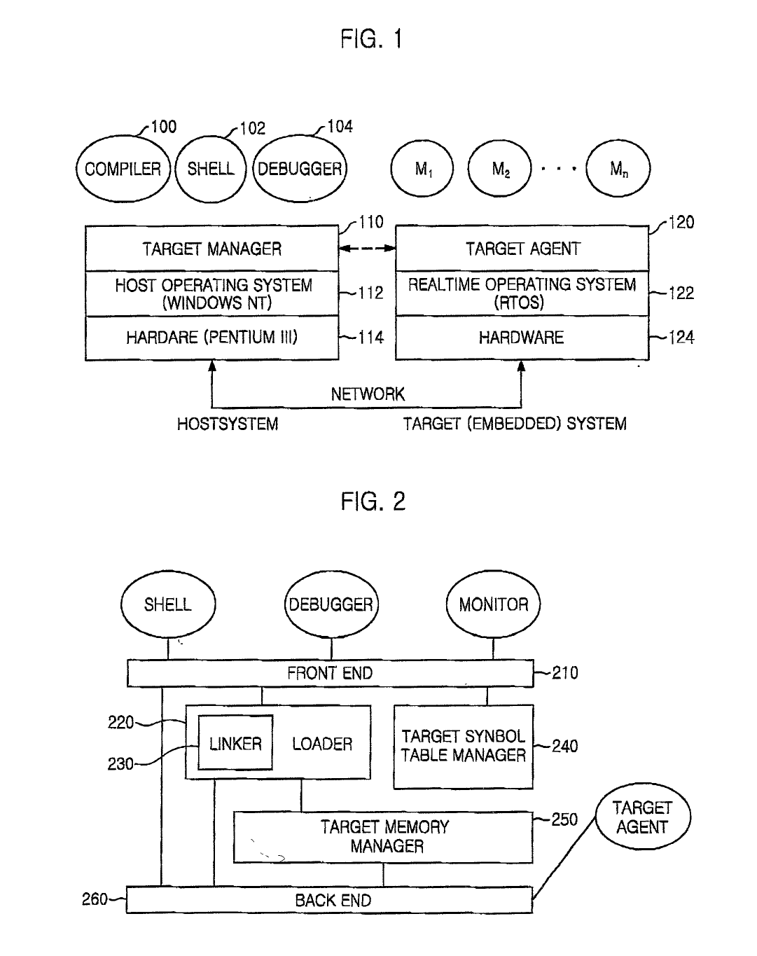

FIG. 1 is a block diagram illustrating a general application program development environment for on-board system.

Referring to FIG. 1, the conventional application program development environment for an on-board system is composed of a host computer and a target system. Developing the application program for the on-board system is performed on the host computer, which has much better performance power than the on-board system. The target system in FIG. 1 is the on-board system. The host system and the target system are connected through a communication network.

The host system has development tools including a target manager 110, a cross compiler 100, a debugger 104, a shell 102 and a resource monitor. The target manager 110 manages the target system. The cross compiler 100 is necessary component for developing an application program.

The development tools are connected to the target system by the target manager 110.

The target manager 110 includes a target agent 120 connected to the target manager 110, a real time operating system 122 and application programs.

The target agent 120 is an independent application program. The target agent 120 is connected to the target manager 110 in the host system and provides necessary target services to the target manager 110 or to development tools of the host system for development of a program.

FIG. 2 is a diagram for illustrating an incremental remote loading apparatus including the target manager in accordance with the preferred embodiment of the present invention.

Referring to FIG. 2, the incremental remote loading apparatus is composed of a front end 210, a loader 220, a target symbol table manager 240, a target memory manager 250 and back end 260. The front end 210 is connected to elements including a compiler, a shell, a monitor and a debugger. The loader 220 downloads a cross-compiled object file from the host to the target system or uploads downloaded modules from the target system to host system. The target symbol table manager 240 manages defined symbols at the target system. The target memory manager 250 manages a target memory.

The loader 220 includes a linker 230. The liker 230 analyzes the cross-compiled object file downloaded from the host system, links the object file to the downloaded modules and downloading to the target system. A linking process is progressed as follows.

The linker 230 links the cross-compiled object file to the modules of the target and downloads the cross-compiled object file to the target system.

The linker 230 is dependent to a type of the object file, therefore, if the target system is changed or the cross-compiler is changed then the linker has to be changed too.

The present invention distinguishes the linker 230 to a dependent part and an independent part according to the type of the object file for minimizing changes of the linker.

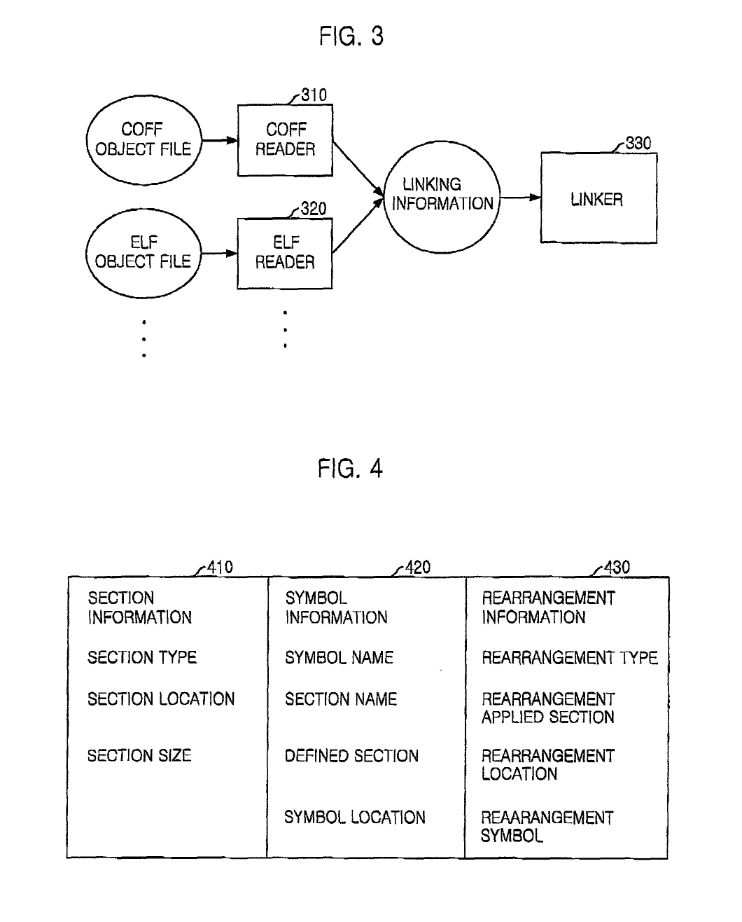

FIG. 3 is a diagram for describing the linker 230 in FIG. 2.

Referring to FIG. 3, the linker 230 includes a COFF reader 310, an ELF leader 320 and a linker 330. The COFF reader 310 is a dependent module on a COFF object file and the ELF reader 320 is a dependent module on an ELF object file. The linker 330 is an independent module from types of the COFF and the ELF object files.

The reader modules 310 and 320 analyze object files dependent on the types of the object files and provide linking information, which are independent from the type of the object file, to the linker module 330.

The linker 330 performs independently linking and downloading base on the linking information. The linking information, referring to FIG. 4, includes section information 410, symbol information 420 and rearrangement information 430.

The section information includes information of a text, a data and a bss section, by which a target memory is occupied. A section type is classified as a text, a data and a bss section. A section location represents an offset value of sections in the object file. A section size represents size information of sections. The text and the data section of the object file are downloaded from the host system to the target system according to its location and size and a region of target memory is allocated to the bss section having un-initialized data value base on the size information.

The symbol information 420 maintains information of symbols defined in the object file and information of symbols defined at outside and undefined in the object file but referenced in the object file.

The symbol type is classified as a defined symbol and an undefined symbol. A defining section is a section in which a symbol is defined and has an index value of the section information. In case of the undefined symbol, the defining section has a value as “0”. The location of the symbol is an offset value of the section in which the symbol is defined. In case of the undefined symbol, the symbol location has a value as “0”.

The rearrangement information 430 maintains information used when rearranging a text and a data section. The rearrangement type has an integer value representing an applying rule containing a rearrangement calculation rule and a rearrangement applying bit number.

The rearrangement applied section is a section to which rearrangement is applied. The rearrangement applied section has an index value of the section information. The rearrangement location is an offset value in the section, which is a rearrangement applied region. The rearrangement symbol is a symbol related to rearrangement and has an index value of the symbol information.

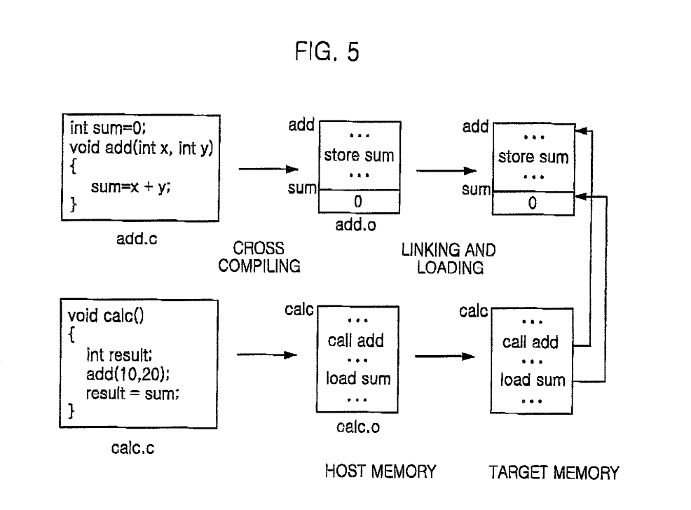

FIG. 5 is a diagram for describing a linking of two C programs.

Referring to FIG. 5, in add.c file, an addition function “add” and a variable “sum” are defined. The variable “sum” contains a result of the function “add”.

In calc.c file, a function “calc” is defined and the function “calc” adds adds two integer numbers.

An object file add.o, which is cross-compiled from “add.c”, has text sections and data sections. The text sections compose the function “add” and the data section composes the variable “sum”.

An object file calc.o, which is cross-compiled from “calc.c”, includes text sections of the function “cal.c”. The function “add” refers the variable “sum” defined in the “add.o” and the function “calc” refers the function “add” and the variable “sum”.

The text and data section of two files are downloaded to the target memory and rearranged according to the function “add” and the variable “sum”.

The linker 230 analyzes necessary linking information for liking two object files add.o and calc.o.

In case the type of the object file is a COFF type, a COFF reader is connected and analyzes the object file. In case the type of the object file is an ELF type, the ELF reader is connected and analyzes the object file.

The analyzed linking information contains unified type information without distinguishing any type of the object file. The analyzed linking information has a structure, as shown in FIG. 4. The second column of each table is an index of each linking information.

In the section information, the section type is classified a text, a data and a bss. The symbol type in the symbol information is classified defined and undefined. Rearrangement types ABS32 and PC24 are examples used in ELF object file type on ARM processor.

The rearrangement type ABS32 is a method that replaces 32 bits in rearrangement region replaces by the address of symbol. The rearrangement type PC24 is a method that replaces 24 bits of 32 bits in rearrangement region the address of the symbol by calculating address of PC.

Inhere, the linker incrementally links and downloads the cross-compiled object files in the host system one by one from the host system to the target system. For example, as shown in FIG. 5, two object files add.o and calc.o are linked to the target system independently without combining as one object file. The linking of two object files is performed by a certain order.

As above-mentioned, the linking with modules in a remote location is progressed incrementally. Such a linking method is called the incremental remote linking.

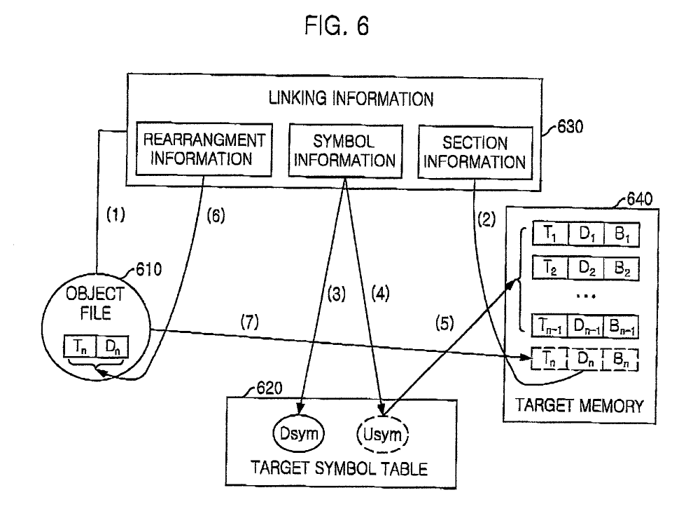

FIG. 6 is a diagram for explaining the incremental remote linking method in accordance with the preferred embodiment of the present invention.

Referring to FIG. 6, Tᵢ is i^{th} module downloaded to the target system or represents i^{th} text section of the object file in the host system, which will be linked to the target. Dᵢ is i^{th} data section and Bᵢ is i^{th} bss section.

In FIG. 6, a left circle 610 is n^{th} object file, which is cross-compiled at the host system and will be linked to the target.

An upper rectangular 630 is linking information analyzed from the object file. A bottom rectangular 630 is a target symbol table maintaining the defined or the referenced symbol, which is already downloaded. Two circles in the target symbol table represent any symbols and D_{sym} is a defined symbol. U_{sym} is an undefined symbol. A right rectangular 640 is a target memory. N-1 numbers of modules are allocated to the memory and dotted-line rectangles are spaces for n^{th} module. Solid lines and arrow lines between circles and rectangulars represent directions of liking progression. The numbers above the lines represent linking order.

The linking and downloading process of n^{th} object file will be described as follows.

1. The linking information including the section information, the symbol information and the rearrangement information is analyzed from the object file 10.

2. The target memory spaces are allocated for a text section Tₙ, data section Dₙ, bss section Bₙ base on the section type and the section size of the section information 20.

3. For each entry of the symbol information,

1] In case the entry is a defined symbol and is not existed on the symbol table 30.

a) A new symbol is generated.

b) A symbol name and an address of target memory is added to the generated symbol.

c) The symbol is registered to the symbol table.

2]. In case the entry is a defined symbol and is existed as an undefined symbol at the symbol table 40.

a) The undefined symbol is transformed to a defined symbol.

b) An address of the target memory is added to the symbol.

c) A rearrangement is applied to the modules of the target system by using the rearrangement information of the undefined symbol.

4. For each entry of the rearrangement information,

1] Symbols related to rearrangement is brought to the symbol table.

2] If the symbol is a defined symbol then an address of the target memory of the symbol and

3] the text and the data section of the object file in the host system are rearranged base on the rearrangement information of the entry 60.

4] If the symbol is an undefined symbol then the rearrangement information is added to the symbol.

5. The rearranged text and data section of the object file is transmitted to the target system 70.

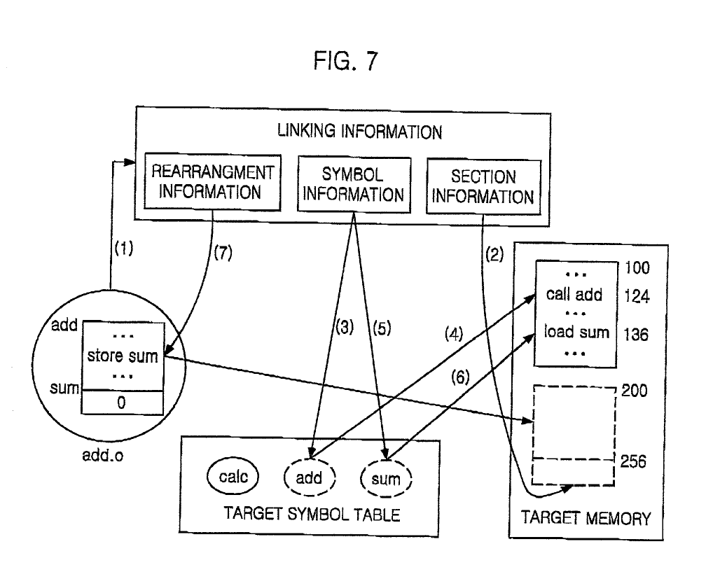

FIG. 7 is a diagram for illustrating incremental remote linking steps of add.o in accordance with the preferred embodiment of the present invention.

1. Linking information is detected from the object file “add.o” 10.

2. 56 bytes text section and 4 bytes data section are allocated to a target memory base on the section information of the object file “add.o” 20. Referring to FIG. 7, an address of the target memory 200 is assigned to the text section and an address of the target memory 256 is assigned to the data section.

3. For each entry of symbol information “add” and “sum”,

1) For the symbol “add”,

a) An undefined symbol “add” of a symbol table is transformed to a defined symbol 30.

b) A reference part of the symbol “add” 124 is rearranged according to the target memory address 200 and the rearrangement information of the symbol “adder” 40.

2) For the symbol “sum”,

a) An undefined symbol “sum” in a symbol table is transformed to a defined symbol 50.

b) A reference part of the symbol “sum” 136 is rearranged according to the target memory address 256 and the rearrangement information of the symbol “add” 60.

4. The reference part of “sum” in the object file “add.o” is rearranged according to the rearrangement information of the linking information and the target memory address of the “sum” 70.

5. The rearranged text section and data section of the object file “add.o” are saved at the target memory.

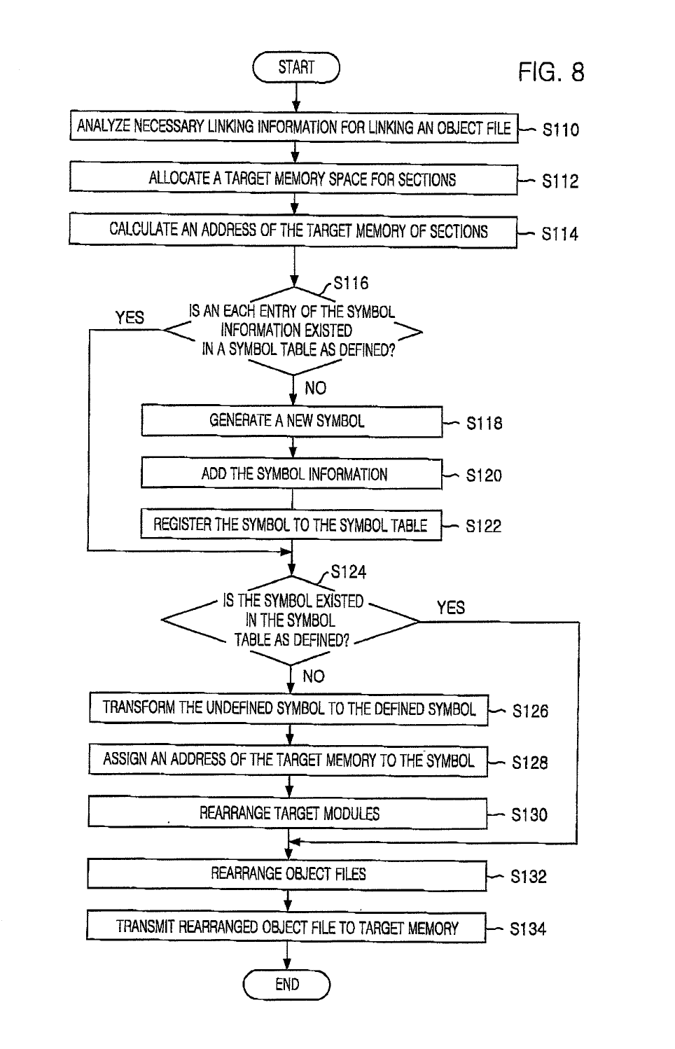

FIG. 8 is a flowchart for describing the incremental remote loading method for the on-board system in accordance with the preferred embodiment of the present invention.

Referring to FIG. 8, at first, a reader module analyzes necessary linking information for linking an object file at step at step S110. At this time, the reader is selected by a type of the object files such as a COFF type and an ELF type. If the object file is the COFF type, then a COFF reader is selected and analyzes necessary information. If the object file is the ELF type, then an ELF reader is selected and analyzes necessary information. The analyzed linking information includes section information, symbol information and rearrangement information regardless of the types of the object files.

The linker allocates a space of the target memory for sections according to the section type and size of the section information at step S112 and calculates an address of the target memory of sections at step S114.

The linker determines an each entry of the symbol information whether the symbol is defined or not and whether the symbol is existed or not at a symbol table at step S116.

If the symbol is existed on the symbol table then the linker determines whether the symbol defined or not at step S124.

If the symbol is not existed on the symbol table then the linker generates a new symbol at step S118, adds the symbol information including a symbol name and an address of the target memory at step S120, resisters the symbol to the symbol table and examines whether the symbol is defined or not in the symbol table at step S124.

If the symbol existed in the symbol table as defined symbol, then the linker rearranges the object file at step S132.

If the symbol existed in the symbol table as undefined symbol, then the linker transforms the undefined symbol to the defined symbol at step S126, assigns an address of the target memory to the symbol at step S128, rearranges modules of the target according to rearrangement of the undefined symbol at step S130 and the linker rearranges the object file at step S132.

The steps of the incremental remote loading are end by transmitting the rearranged the text and data section of the object file to target.

Above-mentioned steps can be implemented as a program and can be saved to a computer-readable recording medium including a CD-ROM, a RAM, a ROM, a floppy disk, a hard disk and a magnetic optical disk.

The present invention provides convenience to an application program developer by providing the incremental remote loading method which links the object files to the target system without a linking order.

The present invention reduces a development time when transporting developing environment to the target system by changing only a dependent environment without changing whole developing environment when the target system is changed.

The present invention reduces necessary communication time between the host system and the target system by dynamically recognizing various object file type, providing necessary operations according to various object file type, partly loading/unloading related modules to target system.

While the present invention has been described with respect to certain preferred embodiments, it will be apparent to those skilled in the art that various changes and modifications may be made without departing from the scope of the invention as defined in the following claims.

What is claimed is:

1. An incremental remote loading apparatus, comprising:
a dependent reader module for receiving a cross-compiled object file from a program development tool, analyzing the cross-compiled object file according to a type of an object file and detecting independent linking information from the type of the object file; and
an independent linker module for receiving the detected liking information from said dependent reader module, downloading the object file to a target system by using the detected linking information and rearranging target modules of the target system.

2. The incremental remote loading apparatus as recited in claim 1, wherein said dependent reader module includes:
a COFF reader module for receiving a cross-compiled COFF object file from said program development tool, analyzing the object file dependently to a COFF type of the object file and detecting independent linking information from the type of the object file; and
an ELF reader module for receiving a cross-compiled ELF object file from the program development tool, analyzing the object file dependently to an ELF type of the object file and detecting independent linking information from the type of the object file.

3. The incremental remote loading apparatus as recited in claim 1, wherein the linking information includes section information, symbol information and rearrangement information.

4. The incremental remote loading apparatus as recited in claims 3, wherein said linker module rearranges not only object files being loaded but also loaded target modules and provides an incremental remote linking, which links object files to the target system without a linking order of the object files.

5. An incremental remote loading method, comprising the steps of:
a) at a reader module, analyzing necessary linking information for liking object files;
b) at a linker, allocating a target memory space for sections according to a section information;
c) determining whether each entry of a symbol table is defined or not and calculating addresses of sections in a target memory;
d) determining, according to a result of said step c), whether a symbol defined or not In case said symbol is stored in said symbol table or inserting a new symbol to the symbol table in case the symbol is not in said symbol table and determining whether the new symbol is defined or not;
e) rearranging an object file if a symbol is defined or rearranging the object file after transforming a defined symbol in case the symbol is not defined; and
f) transmitting a rearranged object file to a target memory.

6. The incremental remote loading method as recited in claim 5, wherein said step a) includes the steps of:
a1) determining a type of the cross-compiled object file;
a2) analyzing the linking information by connecting a COFF reader in case said object file type is a COFF type; and
a3) analyzing the linking information by connecting an ELF reader in case said object file type is an ELF type.

7. The incremental remote loading method as recited in claim 5, wherein said step d) includes the steps of:
d1) generating a new symbol if an entry is not stored in said symbol table and is not a defined symbol;
d2) adding symbol information including a symbol name and an address of a target memory to the new generated symbol; and
d3) registering and inserting the symbol, which is generated and the symbol information added, to the symbol table.

8. The incremental remote loading method as recited claim 5, wherein transforming undefined symbol to defined symbol process in said step e) includes the steps of:
e1) transforming an undefined symbol to an defined symbol if a symbol in a symbol table is undefined; and
e2) adding an address of a target memory and rearranging modules of a target system by using a rearrangement information of said undefined symbol.

9. The incremental remote loading method as recited in claim 5, wherein said step d) includes the steps of:
d1) bringing a rearranged symbol to said symbol table;
d2) rearranging a text and data sections in a host system base on a rearrangement information of an entry and an address of a target memory of a symbol in case said brought symbol is defined; and
d3) adding a rearrangement information to said symbol incase said brought symbol is undefined.

10. A computer-readable recording medium storing instruction for executing an incremental remote loading method, comprising the functions of:
a) analyzing necessary linking information for liking object files by a reader modules;
b) allocating a target memory space for sections according to section information by a linker;
c) determining whether each entry of a symbol table is defined or not and calculating addresses of sections in a target memory;
d) determining, according to a result of said step c), whether a symbol defined or not in case said symbol is stored in said symbol table or inserting a new symbol to the symbol table in case the symbol is not in said symbol table and determining whether the new symbol is defined or not;
e) rearranging an object file if a symbol is defined or rearranging the object file after transforming a defined symbol in ease a symbol is not defined; and
f) transmitting a rearranged object file to a target memory.
